(19) United States
(12) Patent Application Publication
(10) Pub. No.: US 2002/0050205 A1
(43) Pub. Date: May 2, 2002

(54) IMPROVEMENTS IN OR RELATING TO BAGPIPES

(76) Inventor: Charles McMillan, Glasgow, SCT (US)

Correspondence Address: Gifford Krass Groh Sprinkle Anderson & Citkowski, 280 N Old Woodward Avenue Suite 400, Birmingham, MI, 48009, US

(21) Appl. No.: 09/623,666

(22) PCT Filed: Mar. 1, 1999
(86) PCT No.: PCT/GB99/00607

(30) Foreign Application Priority Data
Mar. 6, 1998 (GB) 9804654.3

(51) Int. Cl. G10D 7/00

(52) U.S. Cl. 84/380 B; 84/380 R

(57) ABSTRACT

There is disclosed a fluid trap (125, 225) for use in wind instruments and particularly bagpipes. A problem exists in that during playing a player may tend to secrete oral fluids such as saliva into a blow pipe (15). This fluid may thence tend to descend within the blow pipe (15) through a blow pipe stock (20) into a bag (10), and even down into a chanter (40). To address this problem the fluid trap (125, 225) for use in bagpipes (5) comprises a hollow tubular body (130, 230) adapted to be received within a blow pipe stock (20) of the bagpipes (5).

This invention relates to bagpipes, and in particular, though not exclusively, to Highland bagpipes.

Traditionally Highland bagpipes include a bag having five stocks, one for reception of a blow pipe, one for reception of a chanter, and three for reception of respective drones.

A problem exists in that during playing, a player may tend to secrete oral fluids such as saliva into the blow pipe. This fluid may thence tend to descend within the blow pipe through the blow pipe stock into the bag, and even down into the chanter—thereby causing difficulties in fingering of the instrument.

In order to obviate this problem a number of water traps have been proposed. However, known traps tend to suffer from a number of problems, such as difficulty of installation and removal, adverse effect on the bag, and difficulty in draining.

It is an object of the present invention to obviate or mitigate at least one of the aforementioned problems in the prior art.

According to a first aspect of the present invention there is provided a fluid trap for use in bagpipes, the trap comprising a hollow tubular body adapted to be received within a blow pipe stock of the bagpipes.

Advantageously, the body carries a one way flapper or valve.

Preferably, the trap may be inserted within the stock from an uppermost/outermost end thereof.

Preferably also, the body carries a one way flapper valve.

The body may carry resilient means for retaining the trap within the stock.

Conveniently, the resilient means provide a seal between the body and the stock.

In a preferred embodiment the resilient means provide an annular seal between the body and the stock.

The resilient means may comprise one or more seals such as the O-rings and/or cup seals.

There may be provided a set of interchangeable seals of different sizes so as to allow the trap to be used in differently sized stocks. The stock may have an inner diameter of between 20 mm and 23 mm, and most preferably approximately 20 mm or 22 mm.

The body may comprise an (upper) reduced outer diameter portion, a (lower) enlarged outer diameter portion, and a step portion therebetween.

In use, a fluid chamber may be formed by a portion of an inner wall of the stock, an outer wall of the upper portion of the body and the step portion of the body.

According to a second aspect of the present invention, there is provided a set of bagpipes including a fluid trap, the trap comprising a hollow tubular body adapted to be received within a blow pipe stock of the bagpipes.

These and other aspects of the present invention will now be described, by way of example only, with reference to the accompanying drawings which are:

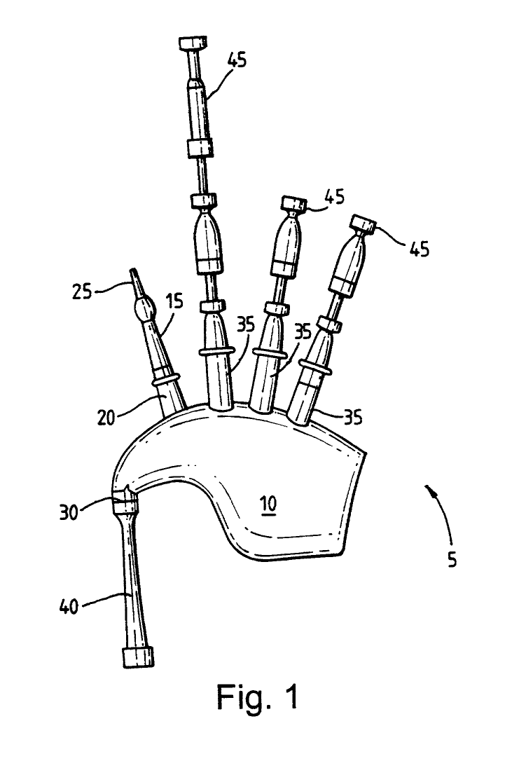

FIG. 1 is a schematic side view of a set of Highland bagpipes including a fluid (water) trap according to the present invention;

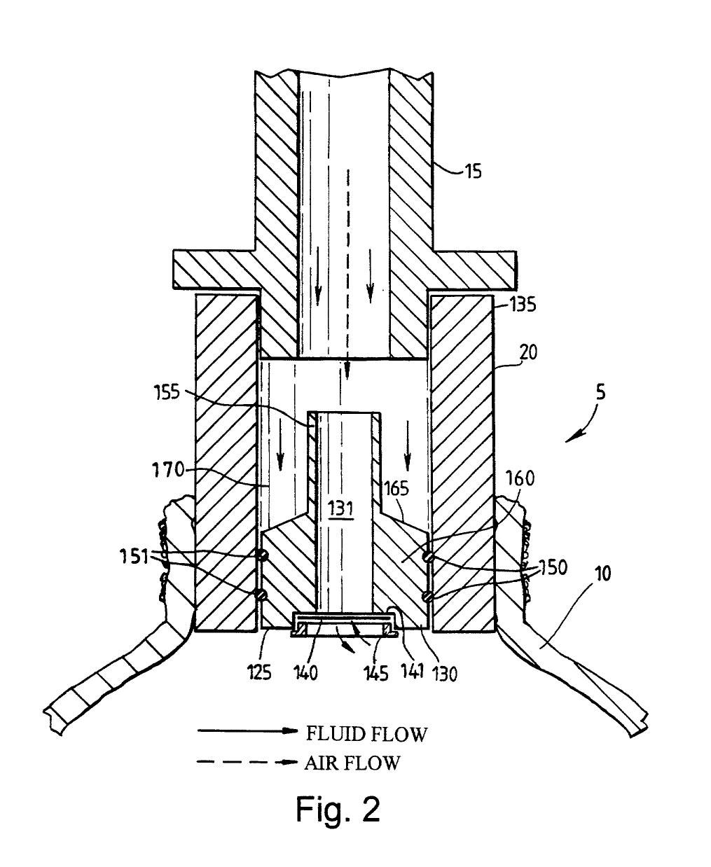

FIG. 2 a partial schematic cross-sectional side view of the Highland bagpipes of FIG. 1 including a fluid trap according to a first embodiment of the present invention; and

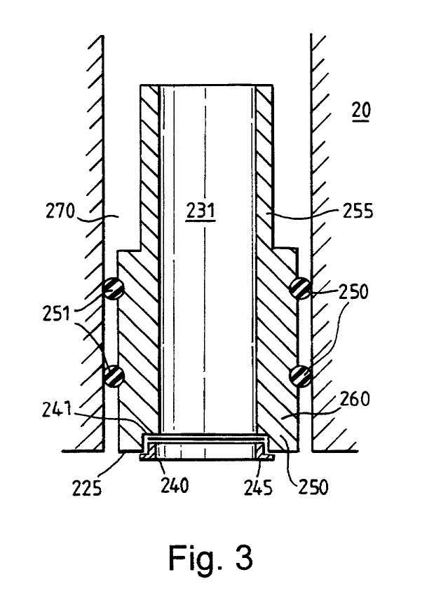

FIG. 3 a partial cross-sectional side view of the Highland bagpipes of FIG. 1 including a fluid trap according to a second embodiment of the present invention.

Referring initially to FIG. 1 there is illustrated a set of Highland bagpipes, generally designated 5. The bagpipes 5 include a bag 10, a blow piece 15 and a blow piece stock 20 adapted for reception of the blow piece 15. The blow piece 15 also carries a mouth piece 25. As well as blow piece stock 20, the bag 10 carries a chanter stock 30 and three drone stocks 35. The chanter stock 30 is adapted for reception of a chanter 40, while the drone stocks 35 are each adapted for reception of one of three drones 45.

Referring now to FIG. 2 the bagpipes 5 further include a fluid trap 125, according to a first embodiment of the present invention. The fluid trap 125 comprises a hollow tubular body 130 having a through-passage 131 and adapted to be received within the blow pipe stock 20 of the bagpipes 5 in a push fit fashion. The trap 125 may be inserted within the stock 20 from an uppermost (outermost) end 135 thereof, and removed in a similar manner.

The body 130 carries a one way flapper valve 140 retained in a recess 141 formed at a lower end of the body 130 by a push fit retaining ring 145.

The body 130 carries resilient means 150 which retain the trap 125 within the stock 120, and which provide an annular seal between the body 130 and the stock 20. The retaining means 150 may conveniently comprise one or more rubber washers or O-rings.

In this embodiment there are provided two rubber washers longitudinally spaced from one another, each being received within an annular recess 151, formed on an outermost wall of the body 130.

The body 130 comprises an upper reduced outer diameter portion 155, a lower increased outer diameter portion 160 and a step portion 165 therebetween.

In use, a fluid chamber 170 is formed by a portion of an inner wall of the stock 20, an outer wall of the upper portion 155 of the body 130, and the step portion 105 of the body 130.

The body 130 may be made of any suitable material, for example, a plastics material or metallic material. For example, the body may be at least partly made of aluminium, or PVC such as Class 7 PVC.

Referring now to FIG. 3 there is illustrated a set of bagpipes 5 including a fluid trap 225 according to a second embodiment of the present invention. The fluid trap 225 is similar to the fluid trap 125 and like parts are identified by like numerals increased by one hundred.

In this embodiment the dimensions of the trap 225 are as follows:

the length of the tubular body 230 is approximately 65 mm;

the outer diameter of the increased outer diameter portion 160 of the tubular body 230 is approximately 19.5 mm;

the outer diameter of the reduced outer diameter portion 155 of the tubular body 230 is approximately 14 mm;

the inner diameter of the tubular body 230 is approximately 12.5 mm;

the diameter of the O-rings is approximately 2.5 mm;

the distance between lower end of the body 230 and centre of adjacent O-ring is approximately 12 mm;

the inner diameter of sock 20 is approximately 21 mm.

In an alternative embodiment:

the length of the tubular body 230 is approximately 38.5 mm;

the outer diameter of the increased outer diameter portion 160 of the tubular body 230 is approximately 20 mm;

the distance between lower end of the body 230 and centre of adjacent O-ring is approximately 16 mm.

The embodiments of the invention hereinbefore described are given by way of example only, and are not meant to limit the scope thereof in any way. In particular, it should be appreciated that the present invention is suitable for use in any blown bagpipes, for example, Highland, Lowland, Irish and/or Northumbrian.

1. Bagpipes (5) including a moisture trap (125; 225), the trap having a hollow tubular body (130; 230) adapted to be received substantially within and to be supported by a blow pipe stock (20) of the bagpipes so as to form a moisture receiving chamber (170; 270) between a portion of the hollow tubular body and a portion of the blow pipe stock, and wherein the hollow tubular body provides a one way valve.

2. Bagpipes as claimed in claim 1, wherein the hollow tubular body carries a one way valve (140; 240).

3. Bagpipes as claimed in either of claims 1 or 2, wherein the portion of the hollow tubular body and the portion of the blow pipe stock form the moisture receiving chamber.

4. Bagpipes as claimed in claim 2, wherein the valve is a flapper valve.

5. Bagpipes as claimed in any of claims 1 to 4, wherein the body carries resilient means (150; 250) for removably retaining the trap within the blow pipe stock.

6. Bagpipes as claimed in claim 5, wherein the resilient means provide at least one seal between the hollow tubular body and the blow pipe stock.

7. Bagpipes as claimed in claim 5, wherein the resilient means provide at least one annular seal between the hollow tubular body and the blow pipe stock.

8. Bagpipes as claimed in any of claims 5 to 7, wherein the resilient means comprise one or more seals selected from O-rings, rubber washers, and cup seals.

9. Bagpipes as claimed in any preceding claim, wherein the hollow tubular body comprises an upwind reduced outer diameter portion (155; 255), a downwind enlarged outer diameter portion (160; 260), and a step portion (105) therebetween.

10. Bagpipes as claimed in claim 9, wherein, in use, the moisture receiving chamber is formed by a portion of an inner wall of the blow pipe stock, an outer wall of the upwind reduced outer diameter portion of the hollow tubular body and the step portion of the hollow tubular body.

11. A moisture trap kit for use in bagpipes (5) according to any of claims 1 to 10, the moisture trap kit comprising the hollow tubular body and a plurality of interchangeable seals each of a different size so as to allow the trap to be received within blow pipe stocks of different sizes.

12. A moisture trap (125; 225) when used in bagpipes according to any of claims 1 to 10, wherein the trap has a hollow tubular body (130; 230) adapted to be received substantially within and be supported by a blow pipe stock (20) of the bagpipes so as to form a moisture receiving chamber (170; 270) between a portion of the hollow tubular body and a portion of the blow pipe stock.

13. A moisture trap (125; 225) for use in bagpipes (5), the trap having a hollow tubular body (130; 230) adapted to be received substantially within and be supported by a blow pipe stock (20) of the bagpipes, the hollow tubular body having an upwind outer portion (155; 255) which forms part of a wall of a moisture receiving chamber (170; 270) and a downwind outer portion, a radius of the upwind outer portion being less than that of the downwind outer portion.

14. A method of providing bagpipes (5) with a moisture trap (125; 225) comprising the steps of:
providing the trap having a hollow tubular body (130; 230);
inserting the trap into a blow pipe stock (20) of the bagpipes such that the trap is received substantially therein and supported thereby so as to form a moisture receiving chamber between at least a portion of the hollow tubular body and a portion of the blow pipe stock.

15. A method of providing bagpipes with a moisture trap as claimed in claim 14, wherein the trap is inserted into and received within the blow pipe stock in a push-fit action from an outermost end (135) of the blow pipe stock.

16. Bagpipes as claimed in claim 1, wherein the tubular body (130; 230) is adapted to be received and retained within the blow pipe stock of the bagpipes by an interference fit between an inner wall of the blow pipe stock and at least one outer portion of the trap.
